(19) United States
(12) Patent Application Publication
(10) Pub. No.: US 2008/0119266 A1
(43) Pub. Date: May 22, 2008

(54) Gaming method providing award standby function, gaming apparatus for performing the gaming method, and computer program product recording a gaming program of the gaming method

(76) Inventor: Arden Yang, Rosemead, CA (US)

Correspondence Address: HARNESS, DICKEY & PIERCE, P.L.C., P.O. BOX 8910, RESTON, VA, 20195, US

(21) Appl. No.: 11/890,506

(22) Filed: Aug. 7, 2007

(30) Foreign Application Priority Data
Nov. 22, 2006 (TW) 095143203

(51) Int. Cl. G07F 1/02

(52) U.S. Cl. 463/25; 463/20

(57) ABSTRACT

A gaming method provides an award standby function and is implemented using a gaming apparatus. The gaming method includes: a) if, during a game, a player obtains an initial predetermined award item, and if the initial predetermined award item is a standby award item, recording the standby award item and providing an indication of the standby award item, and continuing the game; and b) if, during the game, the player obtains an additional predetermined award item, and if the additional predetermined award item satisfies an award grant condition of the standby award item, granting the standby award item to the player. A gaming apparatus and a computer program product are also disclosed.

### CROSS-REFERENCE TO RELATED APPLICATION

This application claims priority of Taiwanese Application No. 095143203, filed on Nov. 22, 2006.

### BACKGROUND OF THE INVENTION

1. Field of the Invention

The present invention relates to a gaming method that provides an award standby function, a gaming apparatus for performing the gaming method, and a computer program product recording a gaming program of the gaming method.

2. Description of the Related Art

Conventional gambling games typically involve betting, gaming, and payout. This is the case in, for example, video poker and slot machine games.

In an effort to maintain player interest, however, there is a continuing need to enhance the gaming experience, ideally without drastically changing the way in which some games are played. In particular, there is a need to develop a new award mechanism that enhances the anticipation associated with and excitement of games, such as existing gambling games. There is a further need to develop a new award mechanism for games that does not necessarily need to be associated with a monetary award.

### SUMMARY OF THE INVENTION

Therefore, the object of this invention is to provide a gaming method that provides an award standby function, a gaming apparatus for performing the gaming method, and a computer program product recording a gaming program of the gaming method.

According to one aspect, the gaming method of this invention provides an award standby function and is implemented using a gaming apparatus. The gaming method comprises: a) if, during a game, a player obtains an initial predetermined award item, and if the initial predetermined award item is a standby award item, recording the standby award item and providing an indication of the standby award item, and continuing the game; and b) if, during the game, the player obtains an additional predetermined award item, and if the additional predetermined award item satisfies an award grant condition of the standby award item, granting the standby award item to the player.

According to another aspect of this invention, the gaming apparatus comprises: an input unit for allowing input by a player; an output unit for displaying a gaming screen; a register unit for temporarily recording data; and a processing unit coupled to the input unit, the output unit, and the register unit, and configured to perform steps of the gaming method of this invention.

According to yet another aspect of this invention, a computer program product comprises a computer-readable storage medium that records a gaming program for causing a computer to execute steps of the gaming method of this invention.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of a gaming apparatus providing an award standby function according to a preferred embodiment of the present invention;

FIG. 2 is a schematic view of an example gaming screen appearing on an output unit of the gaming apparatus of the preferred embodiment; and

FIG. 3 is a flow chart of a gaming method according to a preferred embodiment of the present invention.

### DETAILED DESCRIPTION OF THE PREFERRED EMBODIMENT

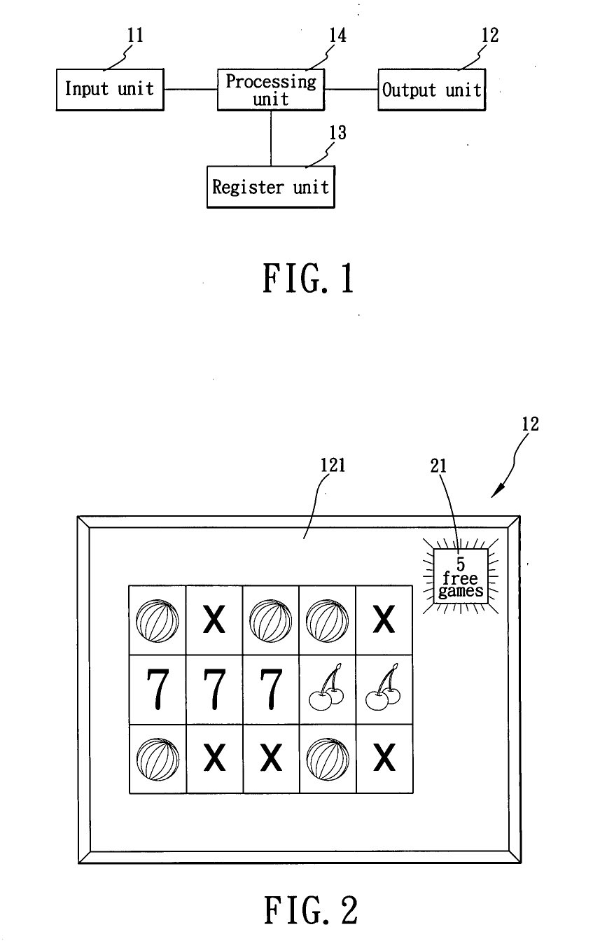

Referring to FIG. 1, a gaming apparatus that provides an award standby function according to a preferred embodiment of the present invention includes an input unit 11, an output unit 12, a register unit 13, and a processing unit 14. The gaming apparatus will be described with reference to FIG. 2 which shows an example gaming screen 121 appearing on the output unit 12. In the example of FIG. 2, the gaming screen 121 is that of a gambling game of slots.

The input unit 11 allows for input by a player to control the gaming apparatus.

The output unit 12 is used to display the gaming screen 121, and is further capable of displaying at least one standby award item 21 on the gaming screen 121. As an example, the output unit 12 may be a computer display. In the example shown in FIG. 2, the standby award item 21 appears on the upper right-hand corner of the gaming screen 121, and reminds the player that he or she is presently in possession of the standby award item 21. If the player obtains further standby award items during a game, then the additional standby award items are arranged in some orderly manner on the gaming screen 121 of the output unit 12, such as aligned along the right side of the gaming screen 121.

The register unit 13 is used to temporarily record data. In the preferred embodiment, the register unit 13 is used to temporarily record the standby award item 21, and possibly additional standby award items.

The processing unit 14 is coupled to the input unit 11, the output unit 12, and the register unit 13. The processing unit 14 is configured to perform steps of a gaming method. The present invention also provides a computer program product comprising a computer-readable storage medium that records a gaming program for causing a computer to execute the steps of a gaming method. As an example, the gaming program may cause the processing unit 14 to execute the steps of the gaming method. Further, the computer-readable storage medium may be a part of the processing unit 14, or may be separate from but accessible by the processing unit 14.

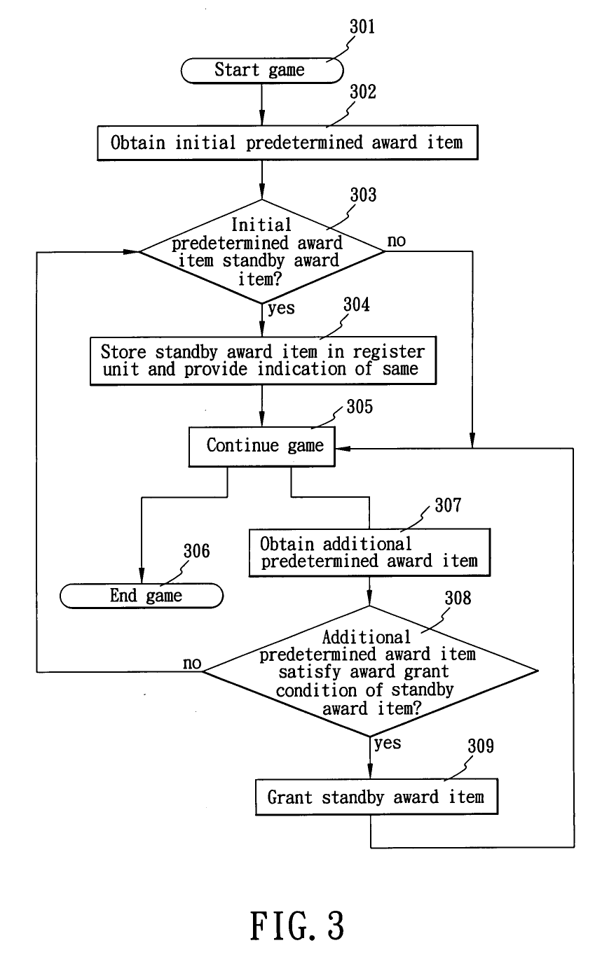

Referring to FIG. 3, a gaming method that provides an award standby function according to a preferred embodiment of the present invention will now be described. The gaming method may be implemented using the gaming apparatus of the preferred embodiment, and may be executed by a computer as part of a gaming program recorded in the computer-readable storage medium of the computer program product of the present invention.

First, in step 301, a game is started.

Next, in step 302, during the game, the player obtains an initial predetermined award item.

Subsequently, in step 303, it is determined if the initial predetermined award item is a standby award item. If so, in step 304, the standby award item is recorded in the register unit 13, and an indication of the standby award item is provided on the output unit 12 so as to remind the player of the fact that he or she has obtained the standby award item. In the example shown in FIG. 2, the standby award item 21 is displayed on the gaming screen 121 of the output unit 12, and indicates “5 free games.” Subsequently, in step 305, the game is continued.

In step 303, if, on the other hand, it is determined that the initial predetermined award item obtained by the player in step 302 is not a standby award item, then step 304 is skipped and step 305 of continuing the game is directly performed.

It is to be noted that the player may choose to end the game in step 306, that is, anytime after the game is continued in step 305. In effect, therefore, the player is allowed to select between continuing the game and ending the game anytime after the standby award item is recorded and displayed in step 304. As an example, step 306 of ending the game may be performed through an interrupt function which is initiated through player manipulation of the input unit 11.

However, if the player does not discontinue the game in step 306, sometime after the game is continued in step 305, an additional predetermined award item is obtained in step 307.

Subsequently, in step 308, it is determined if the additional predetermined award item satisfies an award grant condition of the standby award item. If so, then the standby award item is granted to the player in step 309, after which the flow returns to step 305 of continuing the game.

Returning to the example shown in FIG. 2, assuming that the standby award item 21 is “5 free games” as described above, this is continuously displayed on the output unit 12. Subsequently, if the additional predetermined award item obtained in step 307 is determined to be “grant 5 free games” in step 308 (i.e., the additional predetermined award item satisfies the award grant condition of the standby award item), then the award of “5 free games” is granted to the player in step 309.

In step 308, if, on the other hand, the additional predetermined award item does not satisfy the award grant condition of the standby award item, then the flow returns to step 303. In this case, since this is the second time through the flow of the method, it is determined in step 303 if the additional predetermined award item is an additional standby award item. If so, then, in step 304, the additional standby award item is recorded in the register unit 13 and displayed on the output unit 12 together with the standby award item that was initially obtained, after which the flow continues as described above from step 305.

Although there is no limit to how many times the above process may be repeated, in an effort to make gaming less confusing and further enhance the excitement of the game, the standby award item is canceled and the indication thereof is removed if, during the game, the player does not obtain the additional predetermined award item that satisfies the award grant condition of the standby award item within a predetermined time interval from obtaining the standby award item. This may be applied also to any additional standby award item.

In the present invention described hereinabove, by providing a standby award function in a game, that is, an award that is placed on hold and not immediately granted until certain conditions are met, the anticipation associated with and excitement of a game are enhanced. Furthermore, as described in the example given above, the standby award item need not be associated with a monetary award, such that the game is additionally differentiated from other similar games.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A gaming method providing an award stand by function and implemented using a gaming apparatus, said gaming method comprising:
a) if, during a game, a player obtains an initial predetermined award item, and if the initial predetermined award item is a standby award item, recording the standby award item and providing an indication of the standby award item, and continuing the game; and
b) if, during the game, the player obtains an additional predetermined award item, and if the additional predetermined award item satisfies an award grant condition of the standby award item, granting the standby award item to the player.

2. The gaming method of claim 1, wherein the game is a gambling game.

3. The gaming method of claim 2, wherein the gambling game is a game of slots.

4. The gaming method of claim 1, wherein, in step a), if the initial predetermined award item is not a standby award item, the game is continued.

5. The gaming method of claim 1, further comprising:
if the additional predetermined award item does not satisfy the award grant condition of the standby award item in step b), determining if the additional predetermined award item is an additional standby award item, and if so, recording the additional standby award item.

6. The gaming method of claim 1, further comprising:
canceling the standby award item and removing the indication of the standby award item if, during the game, the player does not obtain the additional predetermined award item that satisfies the award grant condition of the standby award item within a predetermined time interval from obtaining the standby award item.

7. The gaming method of claim 1, wherein, in step a), the player is allowed to select one of ending the game and continuing the game.

8. A gaming apparatus, comprising:
an input unit for allowing input by a player;
an output unit for displaying a gaming screen;
a register unit for temporarily recording data; and
a processing unit coupled to said input unit, said output unit, and said register unit, and configured to perform steps of a gaming method;
wherein the gaming method includes:
a) if, during a game, a player obtains an initial predetermined award item, and if the initial predetermined award item is a standby award item, recording the standby award item in said register unit and providing an indication of the standby award item on said output unit, and continuing the game; and
b) if, during the game, the player obtains an additional predetermined award item, and if the additional predetermined award item satisfies an award grant condition of the standby award item, granting the standby award item to the player.

9. The gaming apparatus of claim 8, wherein the game is a gambling game.

10. The gaming apparatus of claim 9, wherein the gambling game is a game of slots.

11. The gaming apparatus of claim 8, wherein, in step a), if the initial predetermined award item is not a standby award item, the game is continued.

12. The gaming apparatus of claim 8, wherein the gaming method further includes:
if the additional predetermined award item does not satisfy the award grant condition of the standby award item in step b), determining if the additional predetermined award item is an additional standby award item, and if so, recording the additional standby award item in said register unit.

13. The gaming apparatus of claim 8, wherein the gaming method further includes:
canceling the standby award item from said register unit and removing the indication of the standby award item from said output unit if, during the game, the player does not obtain the additional predetermined award item that satisfies the award grant condition of the standby award item within a predetermined time interval from obtaining the standby award item.

14. The gaming apparatus of claim 8, wherein, in step a), the player is allowed to select one of ending the game and continuing the game.

15. A computer program product comprising a computer-readable storage medium that records a gaming program for causing a computer to execute steps of a gaming method including:
a) if, during a game, a player obtains an initial predetermined award item, and if the initial predetermined award item is a standby award item, recording the standby award item and providing an indication of the standby award item, and continuing the game; and
b) if, during the game, the player obtains an additional predetermined award item, and if the additional predetermined award item satisfies an award grant condition of the standby award item, granting the standby award item to the player.

16. The computer program product of claim 15, wherein the game is a gambling game.

17. The computer program product of claim 16, wherein the gambling game is a game of slots.

18. The computer program product of claim 15, wherein, in step a), if the initial predetermined award item is not a standby award item, the game is continued.

19. The computer program product of claim 15, wherein the gaming method further includes:
if the additional predetermined award item does not satisfy the award grant condition of the standby award item in step b), determining if the additional predetermined award item is an additional standby award item, and if so, recording the additional standby award item.

20. The computer program product of claim 15, wherein the gaming method further includes:
canceling the standby award item and removing the indication of the standby award item if, during the game, the player does not obtain the additional predetermined award item that satisfies the award grant condition of the standby award item within a predetermined time interval from obtaining the standby award item.

21. The computer program product of claim 1, wherein, in step a), the player is allowed to select one of ending the game and continuing the game.
